(19) United States
(12) Patent Application Publication
(10) Pub. No.: US 2025/0151116 A1
(43) Pub. Date: May 8, 2025

(54) PHYSICAL RANDOM ACCESS CHANNEL (PRACH) TRANSMISSION USING RANDOM OR PSEUDORANDOM POWER CONTROL

(71) Applicant: QUALCOMM Incorporated, San Diego, CA (US)

(72) Inventors: Jing SUN, San Diego, CA (US); Xiaoxia ZHANG, San Diego, CA (US); Jing JIANG, San Diego, CA (US); Raviteja PATCHAVA, San Diego, CA (US)

(21) Appl. No.: 18/503,008

(22) Filed: Nov. 6, 2023

(51) Int. Cl. H04W 74/08; H04W 52/38

(52) U.S. Cl. CPC H04W 74/0833; H04W 52/38

(57) ABSTRACT

Methods, systems, and devices for wireless communications are described. A user equipment (UE) may transmit, and a network entity may receive, multiple physical random access channel (PRACH) signals at multiple power levels during a time period. The multiple power levels may be randomly or pseudo-randomly selected from within a power range defined for the PRACH signals. The UE may receive a response message indicating one or more of the PRACH signals of the multiple PRACH signals detected during the time period. The UE may transmit a random access request message at a first power level of the multiple power levels according to the one or more PRACH signals of the multiple PRACH signals detected during the time period.

### FIELD OF TECHNOLOGY

The following relates to wireless communications, including physical random access channel (PRACH) transmission using random or pseudorandom power control.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

To perform communications within a wireless network, a UE may perform an association process with a network entity. To initiate the association process, the UE may transmit physical random access channel (PRACH) signaling to the network entity and exchange information with the network entity for use in establishing a communication link between the devices. In some examples, the PRACH signaling may satisfy one or more thresholds for the PRACH signaling to be received by the network entity.

### SUMMARY

The described techniques relate to improved methods, systems, devices, and apparatuses that support physical random access channel (PRACH) transmission using random or pseudorandom power control. For example, the described techniques provide for communications between a user equipment (UE) and a network entity. The UE may transmit, and the network entity may receive, multiple PRACH signals at multiple power levels during a time period. The multiple power levels may be randomly or pseudo-randomly selected from within a power range defined for the PRACH signals. The UE may receive a response message indicating one or more of the PRACH signals of the multiple PRACH signals detected by the network entity during the time period. The UE may transmit a random access request message at a first power level of the multiple power levels according to the response message. In some examples, the UE may receive an indication of a lower bound and an upper bound associated with the power range defined for the multiple PRACH signals. In some examples, the UE may perform one or more open loop power control computations based on one or more parameters to obtain a lower bound and an upper bound associated with the power range. In some examples, the UE may not receive a response message, and may transmit one or more additional sets of multiple PRACH signals at multiple power levels. The multiple power levels of the additional sets may be higher than the multiple power levels of the initial PRACH signals.

A method for wireless communications by a UE is described. The method may include transmitting multiple PRACH signals at multiple power levels during a time period, where the multiple power levels are randomly or pseudo-randomly selected from within a power range defined for the multiple PRACH signals, receiving a response message indicating one or more PRACH signals of the multiple PRACH signals detected during the time period, and transmitting a random access request message at a first power level of the multiple power levels according to the one or more PRACH signals of the multiple PRACH signals detected during the time period.

An apparatus (e.g., UE) for wireless communications is described. The UE may include one or more memories storing processor executable code, and one or more processors coupled with the one or more memories. The one or more processors may individually or collectively operable to execute the code to cause the UE to transmit multiple PRACH signals at multiple power levels during a time period, where the multiple power levels are randomly or pseudo-randomly selected from within a power range defined for the multiple PRACH signals, receive a response message indicating one or more PRACH signals of the multiple PRACH signals detected during the time period, and transmit a random access request message at a first power level of the multiple power levels according to the one or more PRACH signals of the multiple PRACH signals detected during the time period.

Another apparatus (e.g., UE) for wireless communications is described. The UE may include means for transmitting multiple PRACH signals at multiple power levels during a time period, where the multiple power levels are randomly or pseudo-randomly selected from within a power range defined for the multiple PRACH signals, means for receiving a response message indicating one or more PRACH signals of the multiple PRACH signals detected during the time period, and means for transmitting a random access request message at a first power level of the multiple power levels according to the one or more PRACH signals of the multiple PRACH signals detected during the time period.

A non-transitory computer-readable medium storing code for wireless communications is described. The code may include instructions executable by a processor to transmit multiple PRACH signals at multiple power levels during a time period, where the multiple power levels are randomly or pseudo-randomly selected from within a power range defined for the multiple PRACH signals, receive a response message indicating one or more PRACH signals of the multiple PRACH signals detected during the time period, and transmit a random access request message at a first power level of the multiple power levels according to the one or more PRACH signals of the multiple PRACH signals detected during the time period.

Some examples of the method, one or more apparatuses (e.g., UEs), and non-transitory computer-readable medium described herein may further include operations, features, means, or instructions for receiving an indication of a lower bound and an upper bound associated with the power range defined for the multiple PRACH signals.

Some examples of the method, one or more apparatuses (e.g., UEs), and non-transitory computer-readable medium described herein may further include operations, features, means, or instructions for performing a first open loop power control computation based on a first downlink pathloss parameter to obtain a lower bound associated with the power range defined for the multiple PRACH signals and performing a second open loop power control computation based on a second downlink pathloss parameter to obtain an upper bound associated with the power range defined for the multiple PRACH signals.

In some examples of the method, one or more apparatuses (e.g., UEs), and non-transitory computer-readable medium described herein, transmitting the multiple PRACH signals at the multiple power levels may include operations, features, means, or instructions for randomly or pseudo-randomly selecting, for each PRACH signal of the multiple PRACH signals, an offset value such that a power level of the multiple power levels that may be associated with the PRACH signals may be based on a sum of an open loop power control value and the offset value.

Some examples of the method, one or more apparatuses (e.g., UEs), and non-transitory computer-readable medium described herein may further include operations, features, means, or instructions for receiving an indication of a range for the offset value, where a lower bound of the range for the offset value may be zero and an upper bound of the range for the offset value may be based on a power headroom of the UE associated with PRACH transmission.

In some examples of the method, one or more apparatuses (e.g., UEs), and non-transitory computer-readable medium described herein, the multiple power levels may be different from multiple previous power levels associated with a previous time period and the multiple PRACH signals may be transmitted based on a failure to receive a previous response message detected during the previous time period.

In some examples of the method, one or more apparatuses (e.g., UEs), and non-transitory computer-readable medium described herein, the multiple power levels may be higher than the multiple previous power levels.

Some examples of the method, UEs, and non-transitory computer-readable medium described herein may further include operations, features, means, or instructions for receiving an indication of a first set of time resources, frequency resources, or spatial resources associated with the power range.

In some examples of the method, UEs, and non-transitory computer-readable medium described herein, the first set of time resources, frequency resources, or spatial resources may be different from a second set of time resources, frequency resources, or spatial resources associated with an additional power range.

In some examples of the method, UEs, and non-transitory computer-readable medium described herein, the multiple power levels may be randomly or pseudo-randomly selected according to a uniform randomness within the power range defined for the multiple PRACH signals.

In some examples of the method, UEs, and non-transitory computer-readable medium described herein, the multiple power levels may be randomly or pseudo-randomly selected according to a uniform randomness within a defined set of discrete power levels within the power range defined for the multiple PRACH signals.

In some examples of the method, UEs, and non-transitory computer-readable medium described herein, the multiple power levels may be randomly or pseudo-randomly selected according to a random or pseudorandom permutation of a defined set of discrete power levels within the power range defined for the multiple PRACH signals.

In some examples of the method, UEs, and non-transitory computer-readable medium described herein, the multiple power levels includes a first set of discrete power levels that may be randomly or pseudo-randomly selected from a set of multiplemultiple sets of discrete power levels within the power range defined for the multiple PRACH signals.

A method for wireless communications by a network entity is described. The method may include receiving multiple PRACH signals at multiple power levels during a time period, where the multiple power levels are randomly or pseudo-randomly selected from within a power range defined for the multiple PRACH signals, transmitting a response message indicating one or more PRACH signals of the multiple PRACH signals detected during the time period, and receiving a random access request message at a first power level of the multiple power levels according to the one or more PRACH signals of the multiple PRACH signals detected during the time period.

An apparatus (e.g., network entity) for wireless communications is described. The network entity may include one or more memories storing processor executable code, and one or more processors coupled with the one or more memories. The one or more processors may individually or collectively operable to execute the code to cause the network entity to receive multiple PRACH signals at multiple power levels during a time period, where the multiple power levels are randomly or pseudo-randomly selected from within a power range defined for the multiple PRACH signals, transmit a response message indicating one or more PRACH signals of the multiple PRACH signals detected during the time period, and receive a random access request message at a first power level of the multiple power levels according to the one or more PRACH signals of the multiple PRACH signals detected during the time period.

Another apparatus (e.g., network entity) for wireless communications is described. The network entity may include means for receiving multiple PRACH signals at multiple power levels during a time period, where the multiple power levels are randomly or pseudo-randomly selected from within a power range defined for the multiple PRACH signals, means for transmitting a response message indicating one or more PRACH signals of the multiple PRACH signals detected during the time period, and means for receiving a random access request message at a first power level of the multiple power levels according to the one or more PRACH signals of the multiple PRACH signals detected during the time period.

A non-transitory computer-readable medium storing code for wireless communications is described. The code may include instructions executable by a processor to receive multiple PRACH signals multiple power levels during a time period, where the multiple power levels are randomly or pseudo-randomly selected from within a power range defined for the multiple PRACH signals, transmit a response message indicating one or more PRACH signals of the multiple PRACH signals detected during the time period, and receive a random access request message at a first power level of the multiple power levels according to the one or more PRACH signals of the multiple PRACH signals detected during the time period.

Some examples of the method, one or more apparatuses (e.g., network entities), and non-transitory computer-readable medium described herein may further include operations, features, means, or instructions for transmitting an indication of a lower bound and an upper bound associated with the power range defined for the multiple PRACH signals.

Some examples of the method, network entities, and non-transitory computer-readable medium described herein may further include operations, features, means, or instructions for transmitting an indication of a range for an offset value, where a lower bound of the range for the offset value may be zero and an upper bound of the range for the offset value may be based on a power headroom of a UE associated with PRACH transmission.

In some examples of the method, network entities, and non-transitory computer-readable medium described herein, the multiple power levels may be different from multiple previous power levels associated with a previous time period and receiving the multiple PRACH signals may be based on a failure to transmit a previous response message detected during the previous time period.

In some examples of the method, network entities, and non-transitory computer-readable medium described herein, the multiple power levels may be higher than the multiple previous power levels.

Some examples of the method, network entities, and non-transitory computer-readable medium described herein may further include operations, features, means, or instructions for transmitting an indication of a first set of time resources, frequency resources, or spatial resources associated with the power range.

In some examples of the method, network entities, and non-transitory computer-readable medium described herein, the first set of time resources, frequency resources, or spatial resources may be different from a second set of time resources, frequency resources, or spatial resources associated with an additional power range.

### BRIEF DESCRIPTION OF THE DRAWINGS

FIG. 1 shows an example of a wireless communications system that supports physical random access channel (PRACH) transmission using random or pseudorandom power control in accordance with one or more aspects of the present disclosure.

FIG. 2 shows an example of a wireless communications system that supports PRACH transmission using random or pseudorandom power control in accordance with one or more aspects of the present disclosure.

FIG. 3 shows an example of a signaling diagram that supports PRACH transmission using random or pseudorandom power control in accordance with one or more aspects of the present disclosure.

FIG. 4 shows an example of a process flow diagram that supports PRACH transmission using random or pseudorandom power control in accordance with one or more aspects of the present disclosure.

FIGS. 5 and 6 show block diagrams of devices that support PRACH transmission using random or pseudorandom power control in accordance with one or more aspects of the present disclosure.

FIG. 7 shows a block diagram of a communications manager that supports PRACH transmission using random or pseudorandom power control in accordance with one or more aspects of the present disclosure.

FIG. 8 shows a diagram of a system including a device that supports PRACH transmission using random or pseudorandom power control in accordance with one or more aspects of the present disclosure.

FIGS. 9 and 10 show block diagrams of devices that support PRACH transmission using random or pseudorandom power control in accordance with one or more aspects of the present disclosure.

FIG. 11 shows a block diagram of a communications manager that supports PRACH transmission using random or pseudorandom power control in accordance with one or more aspects of the present disclosure.

FIG. 12 shows a diagram of a system including a device that supports PRACH transmission using random or pseudorandom power control in accordance with one or more aspects of the present disclosure.

FIGS. 13 through 16 show flowcharts illustrating methods that support PRACH transmission using random or pseudorandom power control in accordance with one or more aspects of the present disclosure.

### DETAILED DESCRIPTION

User equipments (UEs) may perform a random access process to establish a connection with a network entity. As part of the random access process, the UE may transmit an initial physical random access channel (PRACH) message to the network entity without knowledge of how much transmission power is appropriate to ensure the network entity is able to receive the PRACH message. In some examples, random access techniques include an open loop power control scheme in which the UE transmits the initial PRACH message at an initial transmission power, which may be set based on downlink pathloss measurements, and monitors for a response from the network entity. If no response is received from the network entity, the UE may repeat transmission of the PRACH message, increasing the transmission power of each successive repetition and monitoring for a response until receiving a response from the network entity. Such techniques are time and resource-intensive.

Techniques described herein provide for PRACH transmission using random or pseudorandom power control. The UE may transmit a burst of multiple initial PRACH transmissions (such as a random access preamble or msgA) at randomized transmission power levels before a response is expected from the network entity. The transmit power levels may be randomized within the lower and upper bounds of a defined range. In some examples, the absolute transmission power of each PRACH transmission of the multiple PRACH transmissions may be randomly or pseudo-randomly selected within a range, and the range may be defined by an upper bound and a lower bound configured or computed using an open loop power control equation. In some other examples, the transmission power of each PRACH transmission may be randomly or pseudo-randomly selected from with an offset power range, where the offset power range may be configured or computed as an offset to a base transmission power determined from an open loop power control equation.

In some examples, the UE may transmit multiple sets of multiple PRACH transmissions (e.g., multiple bursts), monitoring between each set of multiple PRACH transmissions (e.g., between each burst) for a response from the network entity, and modifying the defined power range of transmit power levels with each successive burst. Additionally, or alternatively, different PRACH resources may be associated with different transmit power ranges. The PRACH resources over which the UE performs the set of multiple PRACH transmissions may correspond to the transmit power range defined for that particular burst.

Aspects of the disclosure are initially described in the context of wireless communications systems. Aspects of the disclosure are further illustrated by and described with reference to a wireless communications system, signaling diagram, and process flow diagram. Aspects of the disclosure are further illustrated by and described with reference to apparatus diagrams, system diagrams, and flowcharts that relate to PRACH transmission using random or pseudorandom power control.

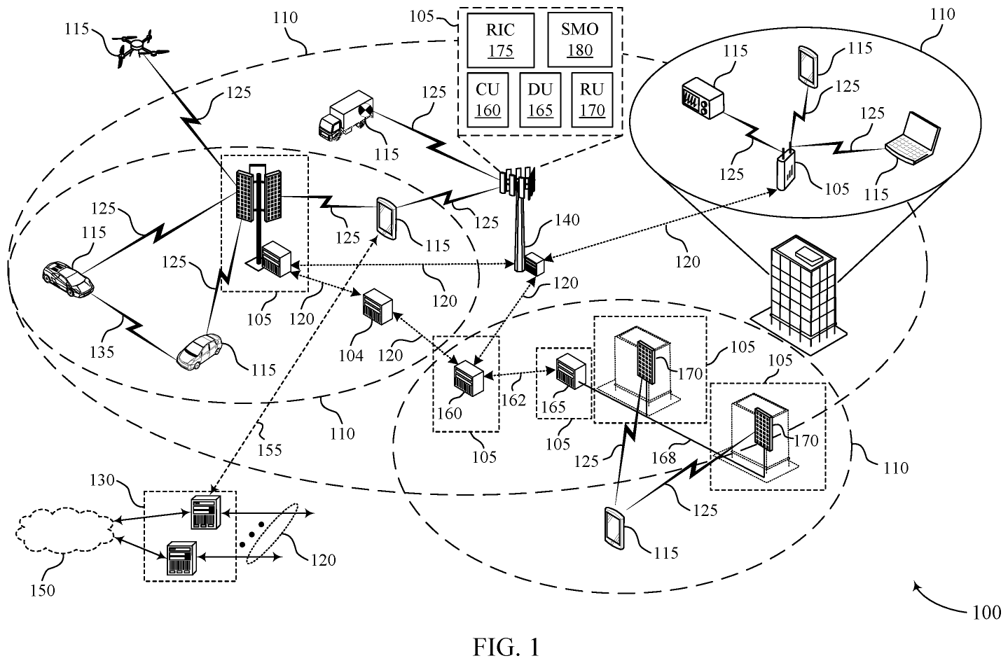

FIG. 1 shows an example of a wireless communications system 100 that supports PRACH transmission using random or pseudorandom power control in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support PRACH transmission using random or pseudorandom power control as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

To support random access between a UE 115 and a network entity 105, the UE 115 may transmit a burst of multiple initial PRACH transmissions at randomized transmission power levels within a range, and then monitor for a response from the network entity 105. In some examples, the absolute transmission power of each PRACH transmission of the multiple PRACH transmissions may be randomly or pseudo-randomly selected within a range, and the range may be defined by an upper bound and a lower bound configured or computed using an open loop power control equation. In some other examples, the transmission power of each PRACH transmission may be randomly or pseudo-randomly selected from with an offset power range, and the offset power range may be configured or computed as an offset to a base transmission power determined from an open loop power control equation.

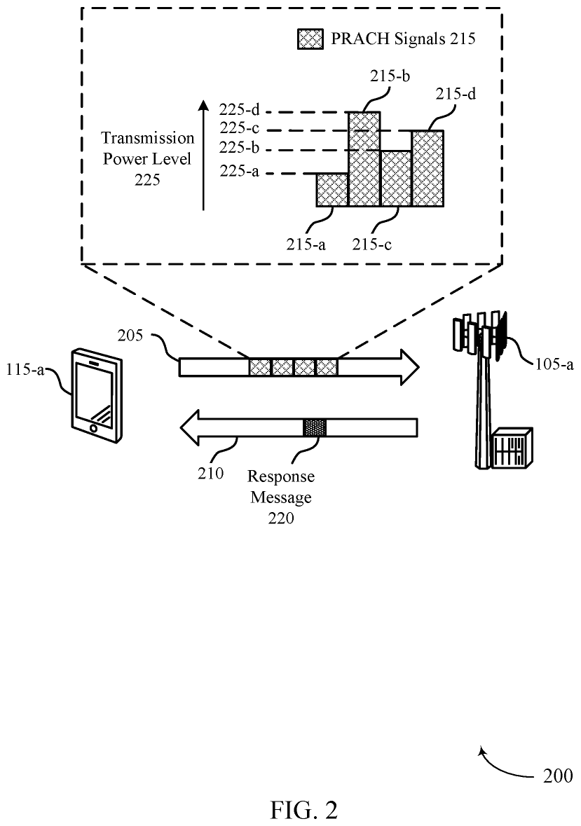

In some examples, the UE 115 may transmit multiple sets of multiple PRACH transmissions (e.g., multiple bursts), monitoring between each set of multiple PRACH transmissions (e.g., between each burst) for a response from the network entity 105, and modifying the defined power range of transmit power levels with each successive burst. Additionally, or alternatively, different PRACH resources may be associated with different transmit power ranges. The PRACH resources over which the UE 115 performs the set of multiple PRACH transmissions may correspond to the transmit power range defined for that particular burst. These techniques are further described with reference to FIGS. 2 through 16.

FIG. 2 shows an example of a wireless communications system 200 that supports PRACH transmission using random or pseudorandom power control in accordance with one or more aspects of the present disclosure. The wireless communications system 200 illustrates an example of one or more PRACH signals 215 (e.g., PRACH signal 215-a, PRACH signal 215-b, PRACH signal 215-c, PRACH signal 215-d) transmitted between a UE 115-a and a network entity 105-a. The UE 115-a may transmit the PRACH signals 215 using random or pseudo-randomly selected one or more transmission power levels 225 (e.g., transmission power level 225-a, transmission power level 225-b, transmission power level 225-c, transmission power level 225-d), and monitor for a response from the network entity 105-a. The PRACH signals 215 may have a corresponding transmission power level 225 (e.g., the PRACH signal 215-a may correspond to the transmission power level 225-a, the PRACH signal 215-b may correspond to the transmission power level 225-b, etc.). The network entity 105-a may transmit a response message 220 to the UE 115-a. The wireless communications system 200 may implement or be implemented by aspects of FIG. 1. The UE 115-a may be an example of the UE 115 as described with reference to FIG. 1, and the network entity 105-a may be an example of the network entity 105 as described with reference to FIG. 1.

The network entity 105-a may communicate (e.g., transmit, output) with the UE 115-a via a downlink 210 (e.g., a communication link, a downlink channel, a physical downlink control channel (PDCCH), a physical downlink shared channel (PDSCH), among other examples). The UE 115-a may communicate (e.g., transmit, output) with the network entity 105-a via an uplink 205 (e.g., a communication link, an uplink channel, a physical uplink control channel (PUCCH), a physical uplink shared channel (PUSCH), among other examples).

The UE 115-a may initiate a random access process to connect with the network entity 105-a. The UE 115-a may transmit an initial PRACH signal 215-a (e.g., a RACH msg1 or msgA transmission containing a random access preamble to initiate random access) using an initial transmission power level 225-a. To determine the initial transmission power level 225-a, the UE 115-a use an open loop power control process. Open loop power control may be based on the assumption that downlink 210 pathloss and uplink 205 pathloss are approximately the same. For example, for a time division duplex (TDD) band and for a frequency division duplex (FDD) band, the power pathloss may be approximately the same for the downlink 210 and the uplink 205. Accurate power transmission is important for the PRACH signal 215-a to reach the intended target. For example, if the transmission power level 225-a is too low, the PRACH signal 215-a may not be detectable by the network entity 105-a.

In some examples, the UE 115-5 may determine the transmission power level 225-a using a downlink power or signal strength measurement, which may be adjusted by various parameters. In some examples, the various parameters, which may be indicated by the network entity 105-a or otherwise configured or indicated, may improve the accuracy of the translation from a downlink measured power to the transmission power level 225-a. In general, the higher the downlink measured power, the less transmission power may be needed, as the UE 115-a may be relatively closer to the network entity 105-a.

However, in some examples, the open loop power control method may not be sufficiently accurate. In some examples, the UE 115-a may perform a power ramping process, where the UE 115-a transmits singular PRACH signals 215 at increasing transmission power levels 225 (e.g., PRACH transmission power levels) using a fixed pattern, following each transmission with a monitoring period. During the monitoring period, the UE 115-a may monitor for a response between each transmission until receiving a response message 220 from the network entity 105-a. For example, the UE 115-a may transmit an initial PRACH signal 215-a at an initial transmission power level 225-a based on the open loop power control (e.g., open power loop equation). The UE 115-a may monitor for a response message 220 from the network entity 105-a, such as a second message (e.g., msg2, msgB containing a random access request (RAR)).

If the UE 115-a does not receive the response message 220 within a time window (e.g., 10 ms), such as an RAR window, the UE 115-a may assume the PRACH signal 215-a was not received and the transmission power level 225-a was not high enough. For example, the network entity 105-a may be unable to detect a PRACH signal 215-a that is transmitted with at a transmission power level 225 that is less than a target transmission power level 225 for detection at the network entity 105-a. The UE 115-a may transmit the PRACH signal 215-a again at a higher transmission power level 225, and monitor again for a response.

By transmitting each subsequent PRACH signal 215 at a higher power level, the UE 115-a may iteratively try different power levels until selecting one that achieves a target transmission power level 225 at the network entity 105-a. If each transmission power level 225 is separated by the same fixed value, the fixed value may be set at a value that balances competing goals of reducing the amount of time (and signaling) used to find a sufficient power level and in selecting a transmission power level 225 that is not higher than needed to achieve the target transmission power level 225 at the network entity 105-a. In some examples, setting the fixed value to a larger value may increase the speed with which a sufficient transmission power level 225 is found (e.g., and reduce the total number of transmission of PRACH signals 215), while setting the fixed value to a lower value may prevent, or reduce an amount of, overshooting the target transmission power level 225. However, setting the fixed value to a higher level may overshoot the target transmission power level 225, resulting in excess and inefficient use of resources, and setting the fixed value to a lower level may require additional transmissions, which may be costly and time consuming.

The UE 115-a may repeat the process of increasing the transmission power level 225 and monitoring from a response until receiving the response message 220 (e.g., RAR message), at which point the transmission power level 225 of the most recent PRACH signal 215 may be considered to be the appropriate transmission power level 225 for further transmissions to reach the network entity 105-a, and the target transmission power level 225 that is detectable by the network entity 105-a. This transmission power level 225 may be sufficient to communicate with the network entity 105-a while avoiding excess power consumption and minimizing interference to neighboring devices. The UE 115-a may use the determined transmission power level 225 for follow-up transmissions, until closed loop power control begins.

The network entity 105-a may transmit the response message 220 in response to detecting one or more PRACH signals 215. The PRACH signals 215 may include a preamble associated with each PRACH signal 215 that the network entity 105-a is able to extract and decode. The network entity 105-a may also be able to determine or derive other related information related from the detected PRACH signals 215, such as the detected power levels, delay offsets, power offsets, other metrics, or a combination thereof.

However, in some examples, the network entity 105-a may not able to determine which UE 115 transmitted the detected PRACH signal 215, or how may detected PRACH signals were transmitted by each UE 115. The network entity 105-a may provide the response message 220 including information identifying the detected PRACH signals 215 to the UE 115-a in order for the UE 115-a to determine which transmission power level 225 are associated with detection at the network entity 105-a. In some examples, the response message 220 may include the preambles of the detected PRACH signals 215, or other information, such as a preamble index or by partial preamble. In some implementations, the response message 220 may include additional information beyond identification of the detected PRACH preamble, such as additional detected information, which may include detected transmission power levels 225, delay offsets, power offsets, or a combination thereof. The UE 115-a may be able to receive the response message 220 including the preambles of the detect PRACH signals 215, or other information, and match the one or more preambles to the one or more transmitted PRACH signals 215, and identify which transmission power levels 225 are associated with detected PRACH signals 215. The UE 115-a may use the lower of the transmission power levels 225 for future transmissions.

In some examples, there may not be a suitable downlink pathloss reference signal. For example, such as for NR supplemental uplink applications, there may be limited uplink 205 coverage in a higher band. To compensate, another lower band uplink 205 carrier may be configured as a supplement to the base uplink 205 carrier for initial access and uplink traffic. In some examples, the network may implement a high band downlink pathloss measurement, and use scaling to compute the pathloss of the lower band. However, this method may result in inaccuracies, but may provide a starting point for a power ramping process.

In some examples, such as for uplink-only transmission reception points (TRPs), there may be additional transmission power level 225 inaccuracies. The UE 115-a may receive downlink communications from one TRP and transmit uplink communications to another TRP. In such examples, the reference signal from the downlink TRP does not provide any reference to the pathloss of the uplink TRIP. A possible method may be to start the PRACH signal 215 transmission with a minimum transmission power level 225, as the UE 115-a does not have indication of the pathloss of the uplink TRP. The UE 115-a may complete a power ramping process until a response message 220 is received. Such a method requires many rounds of transmissions and monitoring periods, and may increase delay for initial access.

In some other examples, similar issues may persist in a flexible duplex example where the downlink 210 is in a higher band and is paired with a lower band uplink 205. In such examples, the downlink 210 and the uplink 205 bands are separated, and the pathloss measured at the downlink band does not provide information for the pathloss of the uplink band.

To accurately and efficiently determine the transmission power level 225 for PRACH signals 215, the UE 115-a may transmit multiple PRACH signals 215 at multiple transmission power levels 225 at a single time, such as in a burst (e.g., set), and then monitor for a response from the network entity 105-a. Each PRACH signal 215 may have a different respective transmission power level 225. For example, the UE 115-a may transmit the PRACH signal 215-a, the PRACH signal 215-b, the PRACH signal 215-c, and the PRACH signal 215-d at the same time, where each PRACH signal 215 corresponds to a different transmission power level 225 (e.g., the transmission power level 225-a, the transmission power level 225-b, etc.).

In some examples, the UE 115-a may determine the multiple transmission power levels 225 randomly or pseudo-randomly. The UE 115-a may randomly or pseudo-randomly determine the transmit power absolutely or based on an offset. By transmitting a burst of multiple PRACH signals 215 at one time at multiple transmission power levels 225, the UE 115-a may reduce the amount of time for monitoring for a response from the network entity 105-a. In some examples, the UE 115-a may transmit one or more additional bursts (e.g., sets) of multiple PRACH signals 215 at increasing transmission power levels 225.

Randomly or pseudo-randomly selecting the transmission power level 225 for each PRACH signal 215 may prevent the UE 115-a from blocking out PRACH signals 215 transmitted by another UE 115 due to differences in noise, path loss, distance, etc. For example, if the UE 115-a is significantly closer to the network entity 105-a than another UE 115, and both transmit PRACH signals 215 according to the same fixed pattern, some of the transmissions of the UE 115-a may be received with high enough power compared to the transmissions of the other UE 115 to interfere with, and possibly prevent, reception of the transmissions of the other UE 115 at transmission power levels 225 that would otherwise be detectable by the network entity 105-a. Randomly or pseudo-randomly selecting the transmission power levels 225 for each PRACH signal 215 transmission decreases the likelihood of interference.

The UE 115-a may determine the multiple transmission power levels 225 using random absolute power. For some scenarios, such as when there is not a downlink pathloss reference signal, there may not be an accurate reference for the transmission power level 225. The UE 115-a may randomly or pseudo-randomly select a transmission power level 225 for each PRACH signal 215 of a burst within a power range. For example, the UE 115-a may randomly or pseudo-randomly select the transmission power level 225-a, the transmission power level 225-b, the transmission power level 225-c, and the transmission power level 225-d from within a power range.

The power range may have a lower bound and an upper bound. The lower bound may be RRC configured through remaining minimum system information (RMSI), or computed by the UE 115-a. For example, the UE 115-a may determine the lower bound by using an open loop power control equation and setting a downlink parameter. In some cases, the UE 115-a may assume the largest downlink pathloss, or the lowest downlink measured power, in the open loop power control equation to set the lower bound. The upper bound of the power range may be configured through RMSI or computed by the UE 115-a. The UE 115-a may use an open loop power equation, and assume the smallest downlink pathloss or highest downlink measured power.

In some examples, the UE 115-a may determine the multiple transmission power levels 225 (e.g., transmit power) using an offset. For some scenarios, such as when there is not a downlink pathloss reference signal and the open loop power configuration is set to a lower power, there may not be an accurate reference for the transmission power level 225. The UE 115-a may randomly or pseudo-randomly select a transmission power level 225 for each PRACH signal 215 of a burst within an offset power range in additional to the open loop power control equation.

The offset power range may have an upper bound and a lower bound. The lower bound of the offset power range may be zero, and the upper bound may be RRC configured through RMSI or based on the UE power headroom for PRACH transmission. The UE 115-a may use the offset power range when the open loop power control setting is at a low power (e.g., conservative setting). The offset power range may be added to the open loop power control when determining the transmission power level 225 of the transmission.

After receiving or determining the upper and lower bounds of the power range (e.g., absolutely power range, offset power range), the UE 115-a may randomly or pseudo-randomly select different transmission power levels 225 for transmission of each PRACH signal 215 within the power range. The UE 115-a may then monitor for a response message 220 from the network entity 105-a.

The response message 220 may include an RAR message indicating which one or more PRACH signals 215 of the multiple PRACH signals 215 was received. The response message 220 indicates to the UE 115-a which of the randomly or pseudo-randomly transmission power levels 225 of the PRACH signals 215 reached the network entity 105-a. The UE 115-a may use the lowest of the response message 220 transmission power levels 225 for further and future transmissions.

The UE 115-a may randomly or pseudo-randomly select transmission power levels 225 using various methods. In some examples, the random or pseudorandom selection may be uniform, where each possible transmission power level 225 within the power range is equally likely to be selected.

In some examples, The UE 115-a may randomly or pseudo-randomly select the transmission power levels 225 of the PRACH signals 215 from a continuous range, or discretely from within a defined set of transmission power levels 225. When selecting from a continuous range, the continuous range may have a defined step size indicating intervals between possible values within the range. The step size may be configured, such as by the network entity 105-a or the network, or otherwise indicated to the UE 115-a. For selecting discretely from within a defined set, the set of random numbers may be configured, such as by the network entity 105-a or the network, or otherwise indicated to the UE 115-a.

In some examples, the UE may be given a set of numbers, such as different transmission power levels 225 or different power offsets, and randomly permute the set and use the values sequentially. This may avoid repetitions and generate a more uniform structure. In some examples, the UE 115 may define a set of transmission power levels 225 or power level offset sequences, or be configured with a set of transmission power levels 225 or power level offset sequences, and randomly select one of the sequences and use the entries in the sequence for PRACH signals 215 transmissions.

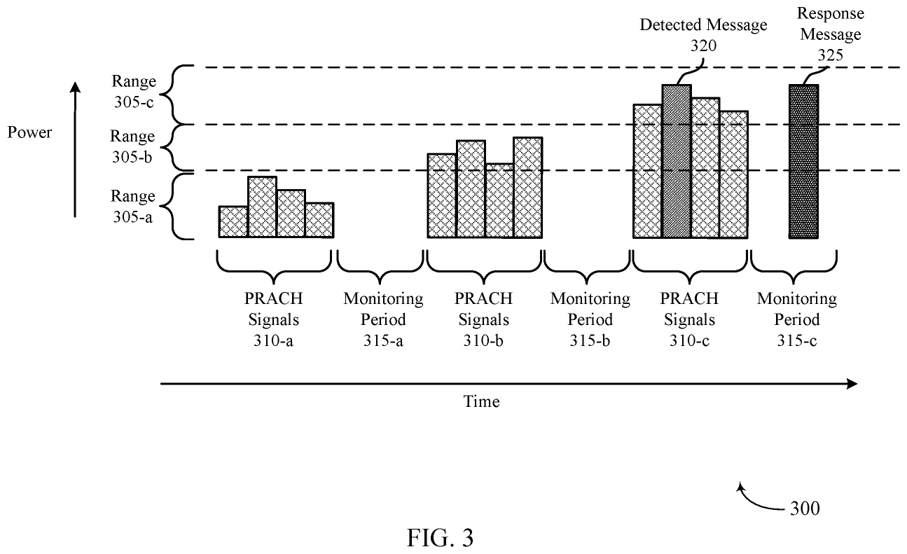

In some examples, the UE 115-a may not receive the response message 220 after the transmission of the PRACH signals 215 in a burst. To determine the transmission power level 225 that is detectable to the network entity 105-a, the UE 115-a may transmit additional bursts of PRACH signals 215 of increasing transmission power levels 225. Such techniques and methods are further described with reference to FIG. 3.

FIG. 3 shows an example of a signaling diagram 300 that supports PRACH transmission using random or pseudorandom power control in accordance with one or more aspects of the present disclosure. The signaling diagram 300 illustrates multiple PRACH signals 310 with random or pseudo-randomly selected transmit power transmitted in multiple bursts at increasing power ranges 305 (e.g., range 305). The signaling diagram 300 may implement or be implemented by aspects of FIG. 1 and FIG. 2. FIG. 3 illustrates communications between the UE and network entity. The PRACH signals 310 may be an example of the PRACH signals 215 as described with reference to FIG. 2, and the response message 330 may be an example of the response message 220 as described with reference to FIG. 2.

In some examples, the dynamic range of PRACH signals 310 transmission power may be large, resulting in inefficiency and inaccuracy when transmitting using multiple power levels (e.g., transmission power levels, power) simultaneously. Additionally, or alternatively, transmissions of higher power may make transmissions of lower power more difficult to detect. For example, the network entity may detect and transmit response messages 325 at multiple power levels, and if the range is large, the UE may not be able to detect the response messages 325 at the lower power levels. FIG. 3 describes an iterative process of transmitting multiple bursts of PRACH signals 310 at multiple power levels, increasing the accuracy of UE detection of response messages 325 as well as improving power level accuracy.

As illustrated in FIG. 3, the UE may transmit a first set of multiple PRACH signals 310-a at multiple randomly or pseudo-randomly selected power levels from with a first power range 305-a. The UE may then monitor for a response from the network entity during a first monitoring period 315-a. The UE may or may not receive a response message. If the UE does not receive a response message, the UE may transmit a second set of multiple PRACH signals 310-b at multiple randomly or pseudo-randomly selected power levels from with a second power range 305-b, and monitor for a response from the network entity during a second monitoring period 315-b. If the UE does not receive a response, the UE may transmit a third set of multiple PRACH signals 310-c at multiple randomly or pseudo-randomly selected power levels from with a third power range 305-c, and monitor for a response from the network entity during a third monitoring period 315-c. If the UE does not receive a response during the third monitoring period 315-c, the UE may transmit a fourth set of multiple PRACH signals 310 at a fourth power range 305 that is greater than the third power range 305-c. The third power range 305-c may be greater than the second power range 305-b, which may be greater than the first power range 305-a.

In some examples, the UE may receive a response during the monitoring period 315. For example, the UE may receive a response message 325 during the monitoring period 315-c. The network entity may detect the message 320 (e.g., detected message 320), at a power level in the power range 305-c. The network entity may transmit the response message 325 in the monitoring period 315-c to the UE. In some examples, the response message 325 may include one or more preambles of the one or more detected messages 320, indicating to the UE 115-a which power levels were detectable by the network entity. In some examples, the response message 325 may be transmitted at the same transmit power as the detected message 320, indicating to the UE the power level required for future transmissions.

In some examples, two UEs may be transmitting PRACH signals 310 at the same time, using the same resources, but with different received powers. While the UEs may implement self-interference cancellation, the transmissions with lower received power may be more difficult to detect than the transmissions with higher power. For example, higher power PRACH signals 310 may block reception of the lower power PRACH signals 310, as the lower power PRACH signals 310 may be harder to detect under the interference from higher power PRACH signals 310 over the same resource. Thus, limiting or defining a range for received power from PRACH signals 310 over non-orthogonal time and frequency resources may reduce interference and improve transmission reception. Such methods may be applicable when there is a downlink pathloss reference signal, among other situations and applications.

In some examples, the power ranges 305 (e.g., ranges) may be further assigned resources. For example, the range 305 may be defined as an offset from open loop power by RRC, such as in the forms of an offset range threshold (e.g., B1, B2, B3), or in addition to the open loop power (O) (e.g., [O, O+B1), [O, O+B1, O+B2), [O, O+B1, O+B2, O+B3), etc.). Separate sub-resource sets may be defined for each range 305 (e.g., RS1, RS2, RS3). For example, PRACH signals 310-a may be assigned a first offset range and a first set of resources (e.g., O, RS1) for the range 305-a. The PRACH signals 310-b, may be assigned a second offset range and a second set of resources (e.g., O+B1, RS2). that are greater than the first set of resources for the PRACH signals 310-a. The UE may select randomly or pseudo-randomly transmit power from within the power range 305 and the assigned set of resources.

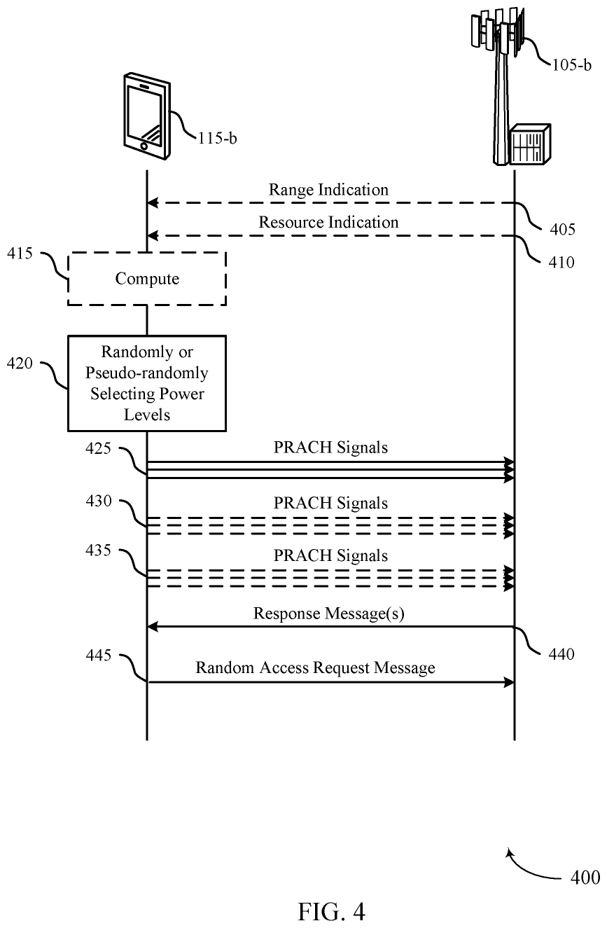

FIG. 4 shows an example of a process flow diagram 400 that supports PRACH transmission using random or pseudorandom power control in accordance with one or more aspects of the present disclosure. The process flow diagram 400 illustrates an example of a UE 115-b using random or pseudorandom power selection for transmitting a burst of PRACH signals, such as msgA or msg1 transmissions including a random access preamble, to a network entity 105-b. The process flow diagram 400 may implement or be implemented by aspects of FIG. 1 through FIG. 3. The UE 115-b may be an example of the UE 115 as described herein, and the network entity 105-b may be an example of the network entity 105 as described herein. Alternative examples of the process flow diagram 400 may be implemented, where some steps are performed in a different order than described or are not performed at all. In some cases, steps may include additional features not mentioned below, or further steps may be added.

At 405, the network entity 105-b may transmit, and the UE 115-b may receive, an indication of a lower bound and an upper bound associated with the power range defined for the multiple PRACH signals.

In some examples, the network entity 105-b may transmit an indication of a range for the offset value, wherein a lower bound of the range for the offset value is zero and an upper bound of the range for the offset value is based on a power headroom of the UE 115-b associated with PRACH transmission.

At 410, the network entity 105-b may transmit, and the UE 115-b may receive, an indication of a first set of time resources, frequency resources, or spatial resources associated with the power range. In some examples, the first set of time resources, frequency resources, or spatial resources may be different from a second set of time resources, frequency resources, or spatial resources associated with an additional power range. For example, the PRACH signals may be transmitted in multiple sets, or bursts, and each set may have different resources. For example, a second set of PRACH signals transmitted after a first set may be associated with an additional power range that is higher than the PRACH signals of the first set, and resources that are different than that of the first set. Subsequent additional transmissions may have higher power ranges and different resources than previous sets of transmissions.

At 415, the UE 115-b may perform a first open loop power control computation based on a first downlink pathloss parameter to obtain a lower bound associated with the power range defined for the multiple PRACH signals. The UE 115-b may perform a second open loop power control computation based on a second downlink pathloss parameter to obtain an upper bound associated with the power range defined for the multiple PRACH signals. Such computations may define an absolute power range.

In some examples, the UE 115-b may determine a range based on an offset value. For example, the offset value may be such that a power level of the multiple power levels is based on a sum of an open loop power control value and the offset value.

At 420, the UE 115-b may randomly or pseudo-randomly select, for each PRACH signal of the multiple PRACH signals, multiple power levels from within a power range defined for the multiple PRACH signals. The power range may be indicated by the network entity 105-b, such as at 405, or computed by the UE 115-b, such as at 415. The power range may be an absolute power range, or a power range based on an offset.

For example, the UE 115-b may randomly or pseudo-randomly select, for each PRACH signal of the multiple PRACH signals, an offset value such that a power level of the multiple power levels is based on a sum of an open loop power control value and the offset value.

In some examples, the multiple power levels may be randomly or pseudo-randomly selected according to a uniform randomness within the power range defined for the multiple PRACH signals. In some examples, the multiple power levels may be randomly or pseudo-randomly selected according to a uniform randomness within a defined set of discrete power levels within the power range defined for the multiple PRACH signals. In some examples, the multiple power levels may be randomly or pseudo-randomly selected according to a random or pseudorandom permutation of a defined set of discrete power levels within the power range defined for the multiple PRACH signals. In some examples, the multiple power levels includes a first set of discrete power levels that may be randomly or pseudo-randomly selected from multiple sets of discrete power levels within the power range defined for the multiple PRACH signals.

At 425, the UE 115-b may transmit, and the network entity 105-b may receive, multiple PRACH signals at multiple power levels during a time period, where the multiple power levels are randomly or pseudo-randomly selected from within a power range defined for the multiple PRACH signals. After transmitting the PRACH signals, the UE may monitor for a response from the network entity 105-b.

At 430, the UE 115-b may transmit multiple PRACH signals (e.g., a second set of multiple PRACH signals) at multiple power levels. In some examples, the multiple power levels may be different from previous multiple power levels associated with a previous time period. The multiple PRACH signals may be transmitted based on a failure to receive a previous response message detected during the previous time period. For example, if the UE 115-b does not receive a response during a monitoring period after transmitting the PRACH signals at 425, the UE 115-b may transmit a second set of multiple PRACH signals at 430. The multiple power levels may be higher than the previous multiple power levels. For example, the multiple power levels of the PRACH signals at 430 may be higher than the multiple power levels of the PRACH signals at 425.

At 435, the UE 115-b may transmit multiple PRACH signals (e.g., a third set of multiple PRACH signals) at multiple power levels. In some examples, the multiple power levels may be different from previous multiple power levels associated with a previous time period and the multiple PRACH signals may be transmitted based on a failure to receive a previous response message detected during the previous time period. The multiple power levels may be higher than the previous multiple power levels. For example, the multiple power levels of the PRACH signals at 435 may be higher than the multiple power levels of the PRACH signals at 430.

At 440, the network entity 105-b may transmit, and the UE 115-b may receive, a response message indicating one or more PRACH signals of the multiple PRACH signals detected during the time period. In some examples, the network entity 105-b may transmit multiple response messages corresponding to multiple received PRACH signals.

The UE 115-b may receive one or more response messages during any monitoring period between each set of multiple PRACH transmissions. For example, the UE 115-b may receive the response message after 435, 430, or 435. In some examples, the UE 115-b may not receive a response after 435, and many continue to transmit multiple PRACH signals at different power ranges until receiving a response message.

At 445, the UE 115-b may transmit, and the network entity 105-b may receive, a random access request message at a first power level of the multiple power levels according to the one or more PRACH signals of the multiple PRACH signals detected during the time period. For example, the response message at 440 may indicate which PRACH signal of the multiple PRACH signals the network entity 105-a received, and the UE 115-b may determine the power level of the received signal. The UE 115-b may use the power level of the received signal for future transmissions to the network entity 105-b.

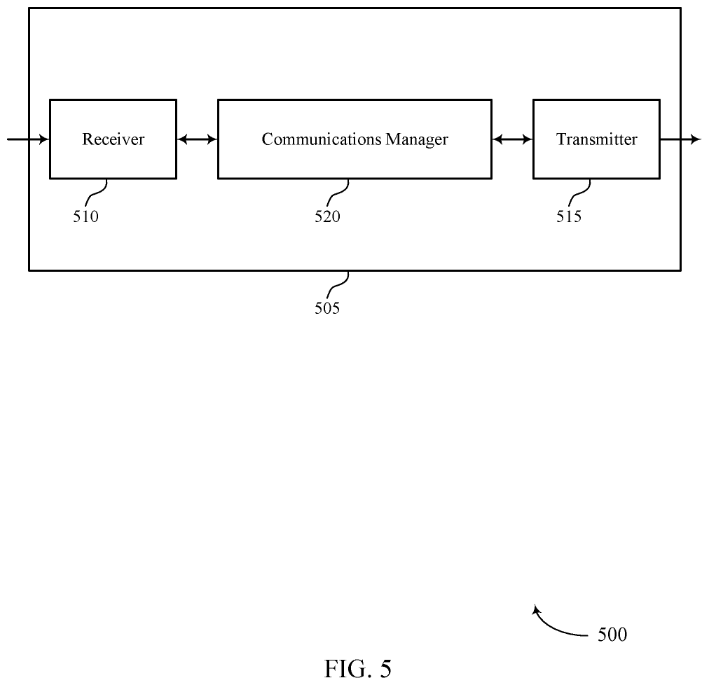

FIG. 5 shows a block diagram 500 of a device 505 that supports PRACH transmission using random or pseudorandom power control in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, and the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to PRACH transmission using random or pseudorandom power control). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to PRACH transmission using random or pseudorandom power control). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of PRACH transmission using random or pseudorandom power control as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor. If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for transmitting a set of multiple PRACH signals at a set of multiple power levels during a time period, where the set of multiple power levels is randomly or pseudo-randomly selected from within a power range defined for the set of multiple PRACH signals. The communications manager 520 is capable of, configured to, or operable to support a means for receiving a response message indicating one or more PRACH signals of the set of multiple PRACH signals detected during the time period. The communications manager 520 is capable of, configured to, or operable to support a means for transmitting a random access request message at a first power level of the set of multiple power levels according to the one or more PRACH signals of the set of multiple PRACH signals detected during the time period.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for PRACH transmission, which may result in various advantages, such as reduced processing, reduced power consumption, and more efficient utilization of communication resources, among other advantages.

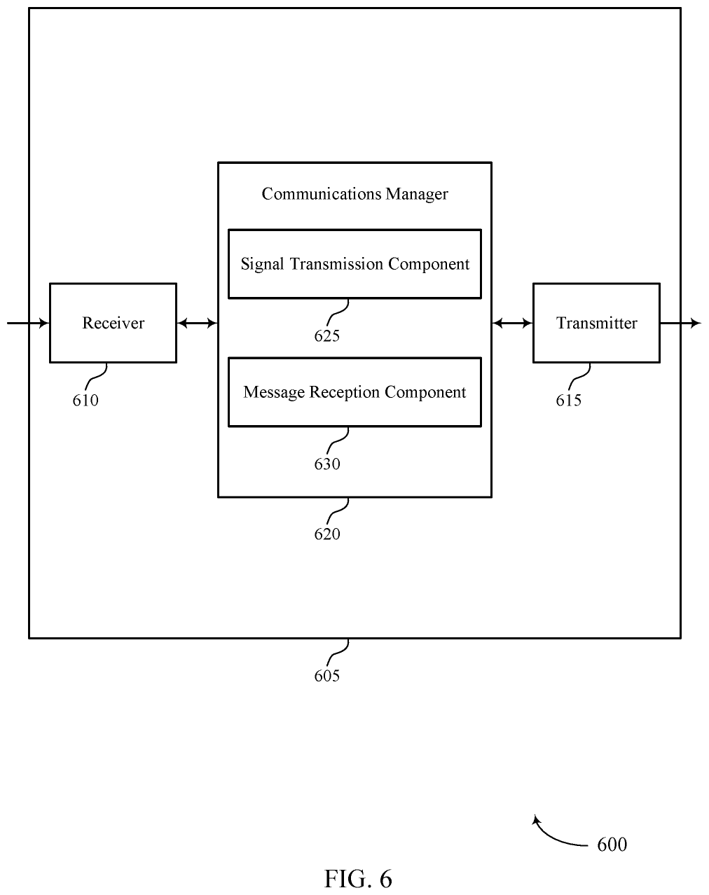

FIG. 6 shows a block diagram 600 of a device 605 that supports PRACH transmission using random or pseudorandom power control in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to PRACH transmission using random or pseudorandom power control). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to PRACH transmission using random or pseudorandom power control). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of PRACH transmission using random or pseudorandom power control as described herein. For example, the communications manager 620 may include a PRACH signal transmission component 625, a message reception component 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The signal transmission component 625 is capable of, configured to, or operable to support a means for transmitting a set of multiple PRACH signals at a set of multiple power levels during a time period, where the set of multiple power levels is randomly or pseudo-randomly selected from within a power range defined for the set of multiple PRACH signals. The signal transmission component 625 is also capable of, configured to, or operable to support a means for transmitting a random access request message at a first power level of the set of multiple power levels according to the one or more PRACH signals of the set of multiple PRACH signals detected during the time period. The message reception component 630 is capable of, configured to, or operable to support a means for receiving a response message indicating one or more PRACH signals of the set of multiple PRACH signals detected during the time period.

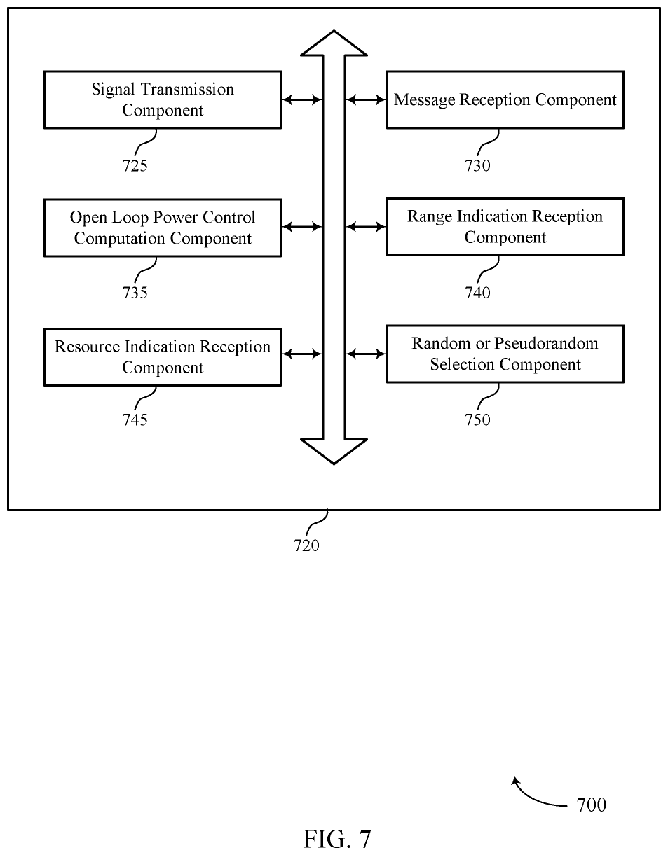

FIG. 7 shows a block diagram 700 of a communications manager 720 that supports PRACH transmission using random or pseudorandom power control in accordance with one or more aspects of the present disclosure. The communications manager 720 may be an example of aspects of a communications manager 520, a communications manager 620, or both, as described herein. The communications manager 720, or various components thereof, may be an example of means for performing various aspects of PRACH transmission using random or pseudorandom power control as described herein. For example, the communications manager 720 may include a signal transmission component 725, a message reception component 730, an open loop power control computation component 735, a range indication reception component 740, a resource indication reception component 745, a random or pseudorandom selection component 750, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The PRACH signal transmission component 725 is capable of, configured to, or operable to support a means for transmitting a set of multiple PRACH signals at a set of multiple power levels during a time period, where the set of multiple power levels is randomly or pseudo-randomly selected from within a power range defined for the set of multiple PRACH signals. The message reception component 730 is capable of, configured to, or operable to support a means for receiving a response message indicating one or more PRACH signals of the set of multiple PRACH signals detected during the time period. In some examples, the open loop power control computation component 735 is capable of, configured to, or operable to support a means for performing a second open loop power control computation based on a second downlink pathloss parameter to obtain an upper bound associated with the power range defined for the set of multiple PRACH signals.

In some examples, the range indication reception component 740 is capable of, configured to, or operable to support a means for receiving an indication of a lower bound and an upper bound associated with the power range defined for the set of multiple PRACH signals. In some examples, the range indication reception component 740 is capable of, configured to, or operable to support a means for receiving an indication of a range for the offset value, where a lower bound of the range for the offset value is zero and an upper bound of the range for the offset value is based on a power headroom of the UE associated with PRACH transmission.

In some examples, the set of multiple power levels is higher than the previous set of multiple power levels. In some examples, the resource indication reception component 745 is capable of, configured to, or operable to support a means for receiving an indication of a first set of time resources, frequency resources, or spatial resources associated with the power range.

In some examples, the first set of time resources, frequency resources, or spatial resources is different from a second set of time resources, frequency resources, or spatial resources associated with an additional power range. In some examples, the set of multiple power levels is randomly or pseudo-randomly selected according to a uniform randomness within the power range defined for the set of multiple PRACH signals.

In some examples, the set of multiple power levels is randomly or pseudo-randomly selected according to a uniform randomness within a defined set of discrete power levels within the power range defined for the set of multiple PRACH signals. In some examples, the set of multiple power levels is randomly or pseudo-randomly selected according to a random or pseudorandom permutation of a defined set of discrete power levels within the power range defined for the set of multiple PRACH signals.

In some examples, the set of multiple power levels includes a first set of discrete power levels that is randomly or pseudo-randomly selected from a set of multiple sets of discrete power levels within the power range defined for the set of multiple PRACH signals.

In some examples, to support transmitting the set of multiple PRACH signals at the set of multiple power levels, the random or pseudorandom selection component 750 is capable of, configured to, or operable to support a means for randomly or pseudo-randomly selecting, for each PRACH signal of the set of multiple PRACH signals, an offset value such that a power level of the set of multiple power is based on a sum of an open loop power control value and the offset value.

In some examples, the set of multiple power levels is different from a previous set of multiple power levels associated with a previous time period and the set of multiple PRACH signals is transmitted based on a failure to receive a previous response message detected during the previous time period.

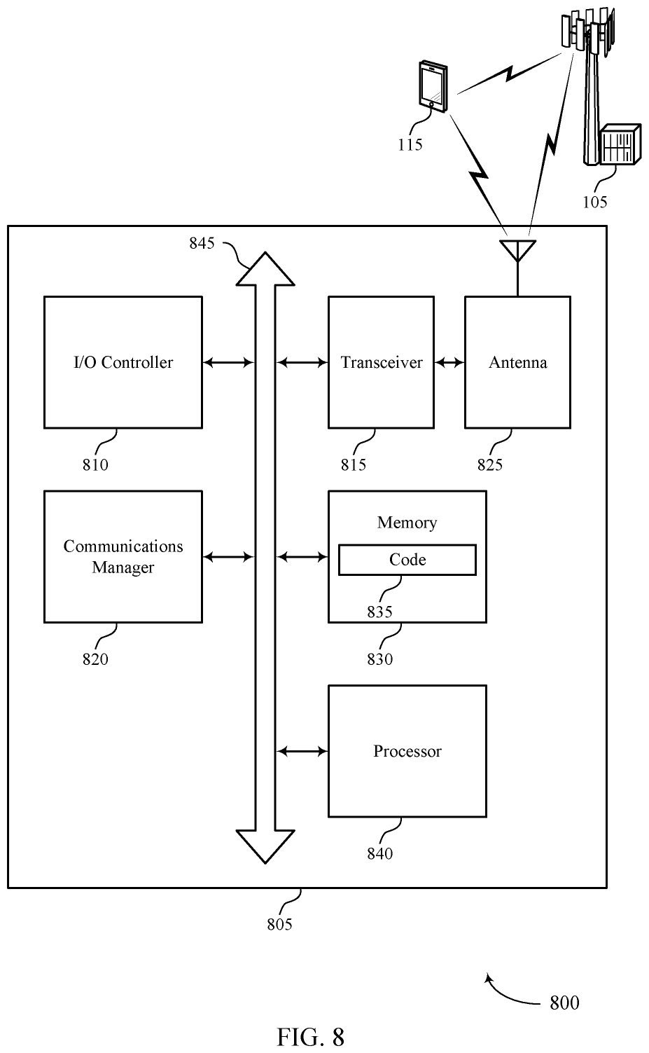

FIG. 8 shows a diagram of a system 800 including a device 805 that supports PRACH transmission using random or pseudorandom power control in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable code 835 including instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may contain, among other things, a basic I/O system (BIOS) which may control basic hardware or software operation such as the interaction with peripheral components or devices.

The at least one processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting PRACH transmission using random or pseudorandom power control). For example, the device 805 or a component of the device 805 may include at least one processor 840 and at least one memory 830 coupled with or to the at least one processor 840, the at least one processor 840 and at least one memory 830 configured to perform various functions described herein. In some examples, the at least one processor 840 may include multiple processors and the at least one memory 830 may include multiple memories. One or more of the multiple processors may be coupled with one or more of the multiple memories, which may, individually or collectively, be configured to perform various functions herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. As such, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for transmitting a set of multiple PRACH signals at a set of multiple power levels during a time period, where the set of multiple power levels is randomly or pseudo-randomly selected from within a power range defined for the set of multiple PRACH signals. The communications manager 820 is capable of, configured to, or operable to support a means for receiving a response message indicating one or more PRACH signals of the set of multiple PRACH signals detected during the time period. The communications manager 820 is capable of, configured to, or operable to support a means for transmitting a random access request message at a first power level of the set of multiple power levels according to the one or more PRACH signals of the set of multiple PRACH signals detected during the time period.

By including or configuring the communications manager 820 in accordance with examples as described herein, the device 805 may support techniques for PRACH transmission, which may result in various advantages, such as improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of PRACH transmission using random or pseudorandom power control as described herein, or the at least one processor 840 and the at least one memory 830 may be otherwise configured to, individually or collectively, perform or support such operations.

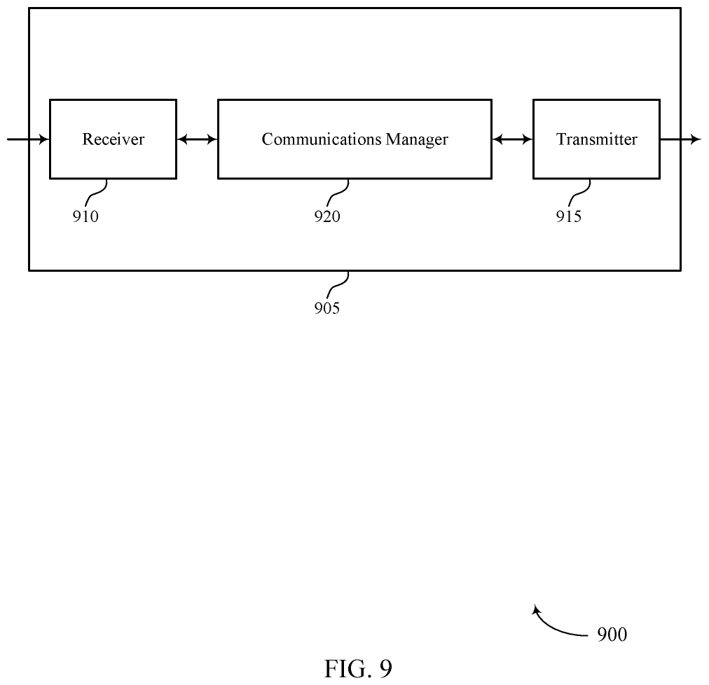

FIG. 9 shows a block diagram 900 of a device 905 that supports PRACH transmission using random or pseudorandom power control in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, and the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of PRACH transmission using random or pseudorandom power control as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor. If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for receiving a set of multiple PRACH signals at a set of multiple power levels during a time period, where the set of multiple power levels are randomly or pseudo-randomly selected from within a power range defined for the set of multiple PRACH signals. The communications manager 920 is capable of, configured to, or operable to support a means for transmitting a response message indicating one or more PRACH signals of the set of multiple PRACH signals detected during the time period. The communications manager 920 is capable of, configured to, or operable to support a means for receiving a random access request message at a first power level of the set of multiple power levels according to the one or more PRACH signals of the set of multiple PRACH signals detected during the time period.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for PRACH transmission, which may result in various advantages, such as reduced processing, reduced power consumption, and more efficient utilization of communication resources, among other advantages.

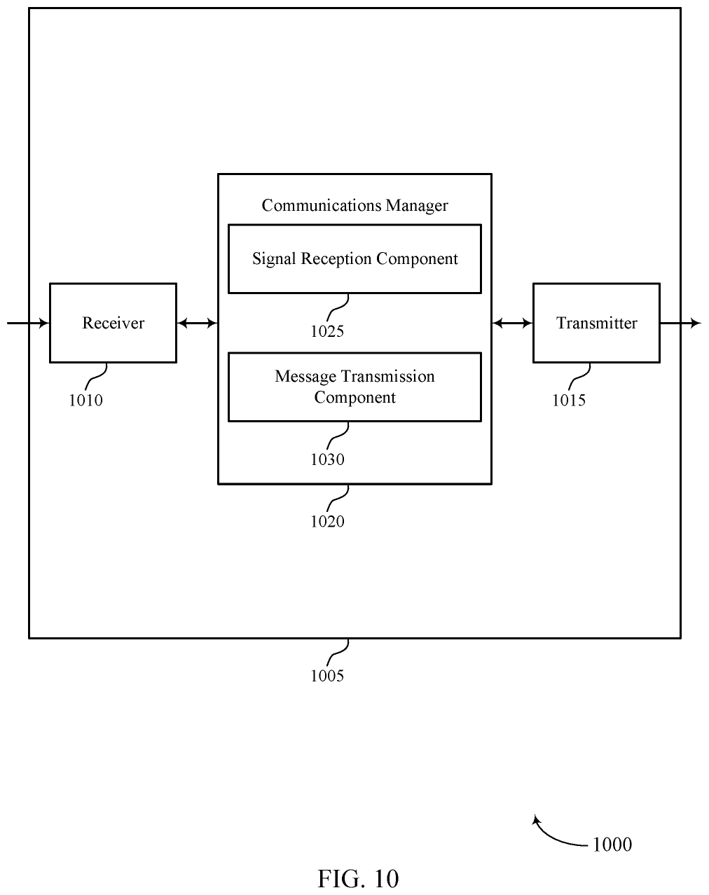

FIG. 10 shows a block diagram 1000 of a device 1005 that supports PRACH transmission using random or pseudorandom power control in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, and the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of PRACH transmission using random or pseudorandom power control as described herein. For example, the communications manager 1020 may include a signal reception component 1025, a message transmission component 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The signal reception component 1025 is capable of, configured to, or operable to support a means for receiving a set of multiple PRACH signals at a set of multiple power levels during a time period, where the set of multiple power levels are randomly or pseudo-randomly selected from within a power range defined for the set of multiple PRACH signals. The signal reception component 1025 is capable of, configured to, or operable to support a means for receiving a random access request message at a first power level of the set of multiple power levels according to the one or more PRACH signals of the set of multiple PRACH signals detected during the time period. The message transmission component 1030 is capable of, configured to, or operable to support a means for transmitting a response message indicating one or more PRACH signals of the set of multiple PRACH signals detected during the time period.

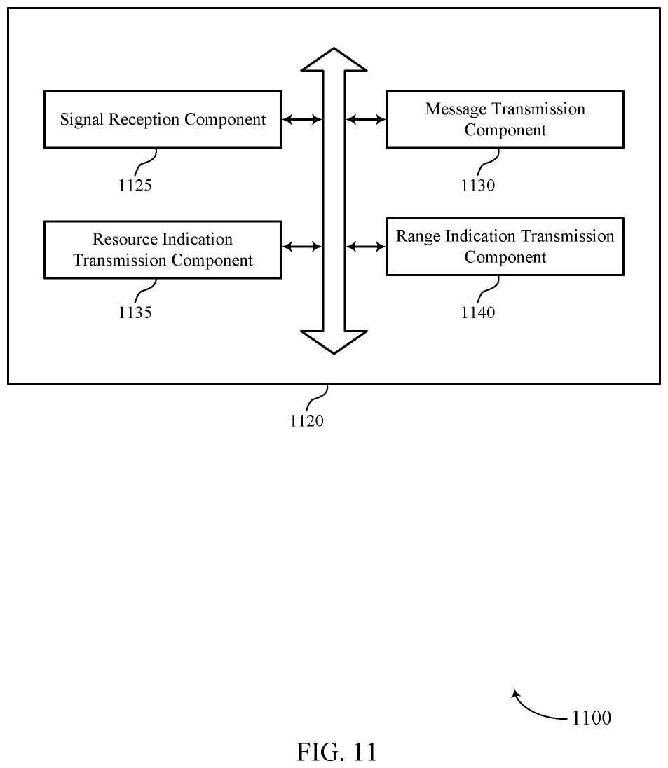

FIG. 11 shows a block diagram 1100 of a communications manager 1120 that supports PRACH transmission using random or pseudorandom power control in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of PRACH transmission using random or pseudorandom power control as described herein. For example, the communications manager 1120 may include a signal reception component 1125, a message transmission component 1130, a resource indication transmission component 1135, a range indication transmission component 1140, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The signal reception component 1125 is capable of, configured to, or operable to support a means for receiving a set of multiple PRACH signals at a set of multiple power levels during a time period, where the set of multiple power levels are randomly or pseudo-randomly selected from within a power range defined for the set of multiple PRACH signals. The signal reception component 1125 is capable of, configured to, or operable to support a means for receiving a random access request message at a first power level of the set of multiple power levels according to the one or more PRACH signals of the set of multiple PRACH signals detected during the time period. The message transmission component 1130 is capable of, configured to, or operable to support a means for transmitting a response message indicating one or more PRACH signals of the set of multiple PRACH signals detected during the time period.

In some examples, the resource indication transmission component 1135 is capable of, configured to, or operable to support a means for transmitting an indication of a first set of time resources, frequency resources, or spatial resources associated with the power range.

In some examples, the first set of time resources, frequency resources, or spatial resources is different from a second set of time resources, frequency resources, or spatial resources associated with an additional power range.

In some examples, the range indication transmission component 1140 is capable of, configured to, or operable to support a means for transmitting an indication of a lower bound and an upper bound associated with the power range defined for the set of multiple PRACH signals.

In some examples, the range indication transmission component 1140 is capable of, configured to, or operable to support a means for transmitting an indication of a range for an offset value, where a lower bound of the range for the offset value is zero and an upper bound of the range for the offset value is based on a power headroom of a UE associated with PRACH transmission.

In some examples, the set of multiple power levels is different from a previous set of multiple power levels associated with a previous time period and receiving the set of multiple PRACH signals is based on a failure to transmit a previous response message detected during the previous time period.

In some examples, the set of multiple power levels is higher than the previous set of multiple power levels.

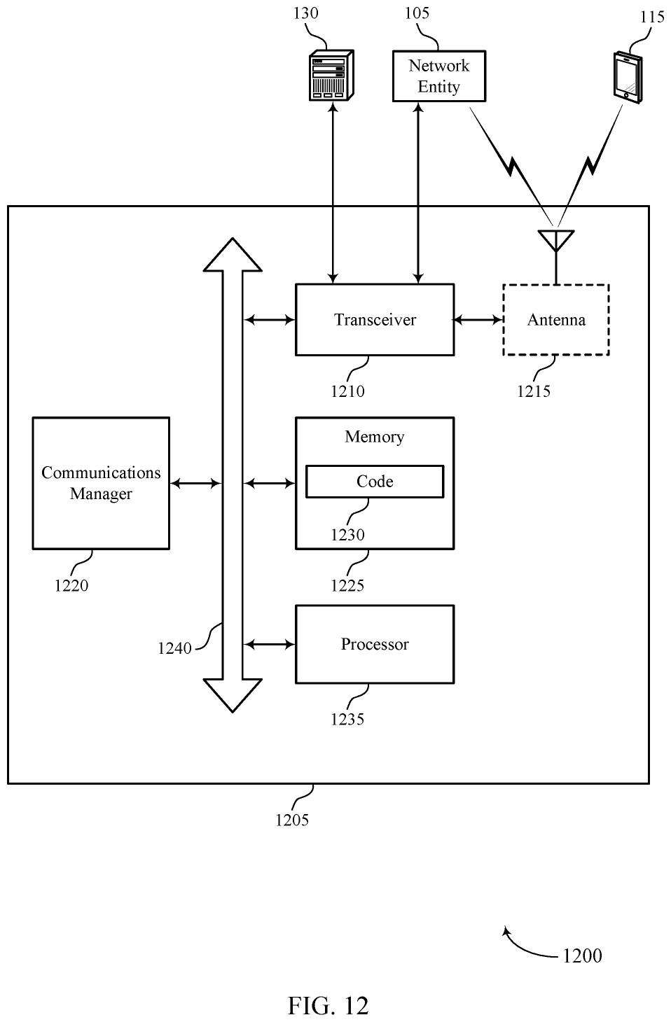

FIG. 12 shows a diagram of a system 1200 including a device 1205 that supports PRACH transmission using random or pseudorandom power control in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., a communication link 125, a backhaul communication link 120, a midhaul communication link 162, a fronthaul communication link 168).

The at least one memory 1225 may include RAM, ROM, or any combination thereof. The at least one memory 1225 may store computer-readable, computer-executable code 1230 including instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may contain, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting PRACH transmission using random or pseudorandom power control). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225). In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. As such, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for receiving a set of multiple PRACH signals at a set of multiple power levels during a time period, where the set of multiple power levels are randomly or pseudo-randomly selected from within a power range defined for the set of multiple PRACH signals. The communications manager 1220 is capable of, configured to, or operable to support a means for transmitting a response message indicating one or more PRACH signals of the set of multiple PRACH signals detected during the time period. The communications manager 1220 is capable of, configured to, or operable to support a means for receiving a random access request message at a first power level of the set of multiple power levels according to the one or more PRACH signals of the set of multiple PRACH signals detected during the time period.

By including or configuring the communications manager 1220 in accordance with examples as described herein, the device 1205 may support techniques for PRACH transmission, which may result in various advantages, such as improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of PRACH transmission using random or pseudorandom power control as described herein, or the at least one processor 1235 and the at least one memory 1225 may be otherwise configured to, individually or collectively, perform or support such operations.

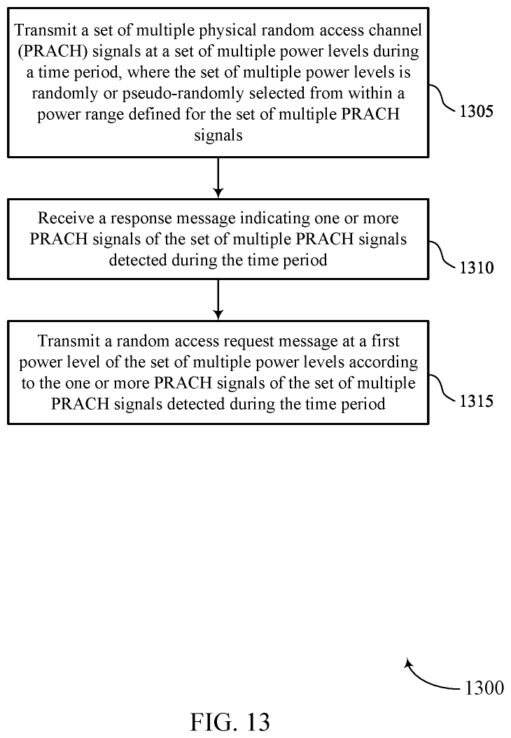

FIG. 13 shows a flowchart illustrating a method 1300 that supports PRACH transmission using random or pseudorandom power control in accordance with aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include transmitting a set of multiple PRACH signals at a set of multiple power levels during a time period, where the set of multiple power levels is randomly or pseudo-randomly selected from within a power range defined for the set of multiple PRACH signals. The operations of block 1305 may be performed in accordance with examples as disclosed herein. In some examples, aspects of the operations of 1305 may be performed by a PRACH signal transmission component 725 as described with reference to FIG. 7.

At 1310, the method may include receiving a response message indicating one or more PRACH signals of the set of multiple PRACH signals detected during the time period. The operations of block 1310 may be performed in accordance with examples as disclosed herein. In some examples, aspects of the operations of 1310 may be performed by a message reception component 730 as described with reference to FIG. 7.

At 1315, the method may include transmitting a random access request message at a first power level of the set of multiple power levels according to the one or more PRACH signals of the set of multiple PRACH signals detected during the time period. The operations of block 1315 may be performed in accordance with examples as disclosed herein. In some examples, aspects of the operations of 1315 may be performed by a message transmission component 725 as described with reference to FIG. 7.

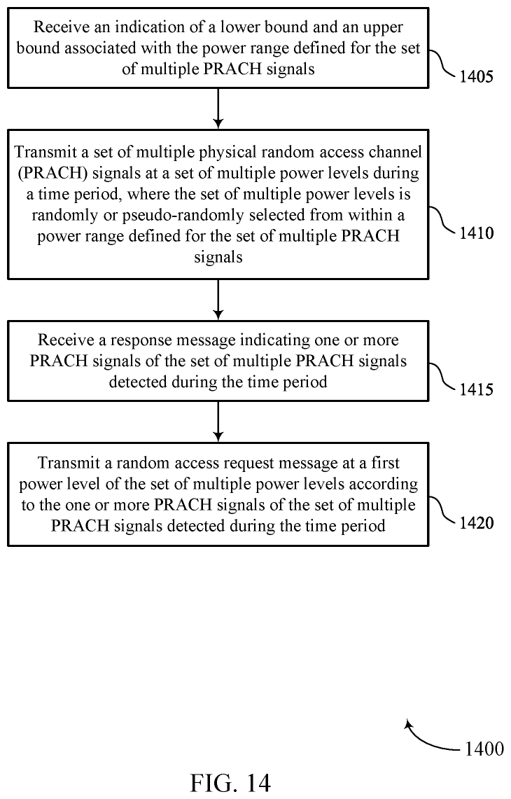

FIG. 14 shows a flowchart illustrating a method 1400 that supports PRACH transmission using random or pseudorandom power control in accordance with aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving an indication of a lower bound and an upper bound associated with the power range defined for the set of multiple PRACH signals. The operations of block 1405 may be performed in accordance with examples as disclosed herein. In some examples, aspects of the operations of 1405 may be performed by a range indication reception component 740 as described with reference to FIG. 7.

At 1410, the method may include transmitting a set of multiple PRACH signals at a set of multiple power levels during a time period, where the set of multiple power levels is randomly or pseudo-randomly selected from within a power range defined for the set of multiple PRACH signals. The operations of block 1410 may be performed in accordance with examples as disclosed herein. In some examples, aspects of the operations of 1410 may be performed by a PRACH signal transmission component 725 as described with reference to FIG. 7.

At 1415, the method may include receiving a response message indicating one or more PRACH signals of the set of multiple PRACH signals detected during the time period. The operations of block 1415 may be performed in accordance with examples as disclosed herein. In some examples, aspects of the operations of 1415 may be performed by a message reception component 730 as described with reference to FIG. 7.

At 1420, the method may include transmitting a random access request message at a first power level of the set of multiple power levels according to the one or more PRACH signals of the set of multiple PRACH signals detected during the time period. The operations of block 1420 may be performed in accordance with examples as disclosed herein. In some examples, aspects of the operations of 1420 may be performed by a signal transmission component 725 as described with reference to FIG. 7.

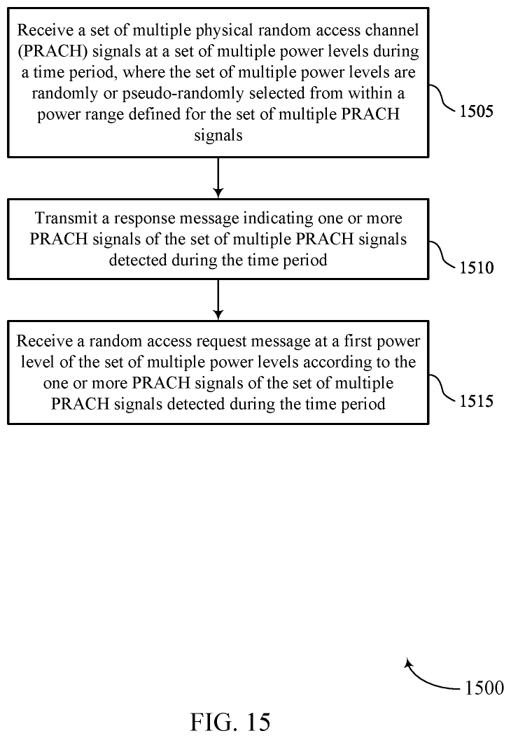

FIG. 15 shows a flowchart illustrating a method 1500 that supports PRACH transmission using random or pseudorandom power control in accordance with aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include receiving a set of multiple PRACH signals at a set of multiple power levels during a time period, where the set of multiple power levels are randomly or pseudo-randomly selected from within a power range defined for the set of multiple PRACH signals. The operations of block 1505 may be performed in accordance with examples as disclosed herein. In some examples, aspects of the operations of 1505 may be performed by a PRACH signal reception component 1125 as described with reference to FIG. 11.

At 1510, the method may include transmitting a response message indicating one or more PRACH signals of the set of multiple PRACH signals detected during the time period. The operations of block 1510 may be performed in accordance with examples as disclosed herein. In some examples, aspects of the operations of 1510 may be performed by a message transmission component 1130 as described with reference to FIG. 11.

At 1515, the method may include receiving a random access request message at a first power level of the set of multiple power levels according to the one or more PRACH signals of the set of multiple PRACH signals detected during the time period. The operations of block 1515 may be performed in accordance with examples as disclosed herein. In some examples, aspects of the operations of 1515 may be performed by a signal reception component 1125 as described with reference to FIG. 11.

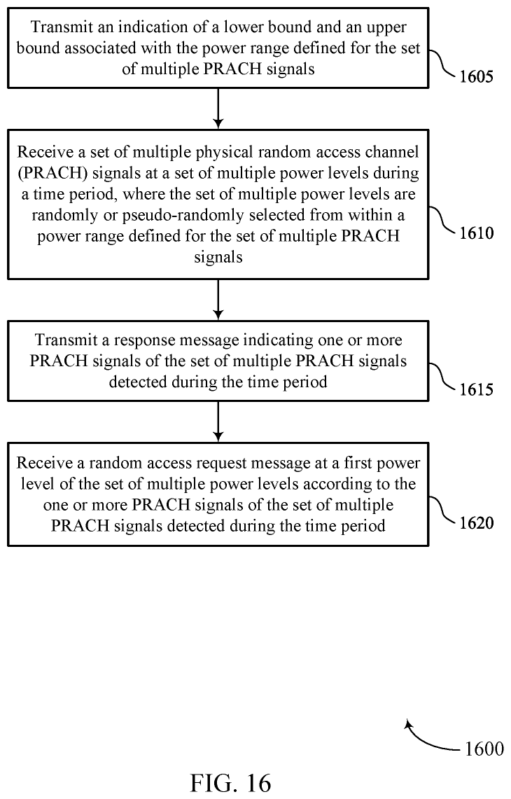

FIG. 16 shows a flowchart illustrating a method 1600 that supports PRACH transmission using random or pseudorandom power control in accordance with aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include transmitting an indication of a lower bound and an upper bound associated with the power range defined for the set of multiple PRACH signals. The operations of block 1605 may be performed in accordance with examples as disclosed herein. In some examples, aspects of the operations of 1605 may be performed by a range indication transmission component 1140 as described with reference to FIG. 11.

At 1610, the method may include receiving a set of multiple PRACH signals at a set of multiple power levels during a time period, where the set of multiple power levels are randomly or pseudo-randomly selected from within a power range defined for the set of multiple PRACH signals. The operations of block 1610 may be performed in accordance with examples as disclosed herein. In some examples, aspects of the operations of 1610 may be performed by a PRACH signal reception component 1125 as described with reference to FIG. 11.

At 1615, the method may include transmitting a response message indicating one or more PRACH signals of the set of multiple PRACH signals detected during the time period. The operations of block 1615 may be performed in accordance with examples as disclosed herein. In some examples, aspects of the operations of 1615 may be performed by a message transmission component 1130 as described with reference to FIG. 11.

At 1620, the method may include receiving a random access request message at a first power level of the set of multiple power levels according to the one or more PRACH signals of the set of multiple PRACH signals detected during the time period. The operations of block 1620 may be performed in accordance with examples as disclosed herein. In some examples, aspects of the operations of 1620 may be performed by a signal reception component 1125 as described with reference to FIG. 11.

The following provides an overview of aspects of the present disclosure:

Aspect 1: A method for wireless communications at a UE, comprising: transmitting multiple PRACH signals at multiple power levels during a time period, wherein the multiple power levels are randomly or pseudo-randomly selected from within a power range defined for the multiple PRACH signals; receiving a response message indicating one or more PRACH signals of the multiple PRACH signals detected during the time period; and transmitting a random access request message at a first power level of the multiple power levels according to the one or more PRACH signals of the multiple PRACH signals detected during the time period.

Aspect 2: The method of aspect 1, further comprising: receiving an indication of a lower bound and an upper bound associated with the power range defined for the multiple PRACH signals.

Aspect 3: The method of any of aspects 1 through 2, further comprising: performing a first open loop power control computation based at least in part on a first downlink pathloss parameter to obtain a lower bound associated with the power range defined for the multiple PRACH signals; and performing a second open loop power control computation based at least in part on a second downlink pathloss parameter to obtain an upper bound associated with the power range defined for the multiple PRACH signals.

Aspect 4: The method of any of aspects 1 through 3, wherein transmitting the multiple PRACH signals at the multiple power levels comprises: randomly or pseudo-randomly selecting, for each PRACH signal of the multiple PRACH signals, an offset value such that a power level of the multiple power levels is based at least in part on a sum of an open loop power control value and the offset value.

Aspect 5: The method of aspect 4, further comprising: receiving an indication of a range for the offset value, wherein a lower bound of the range for the offset value is zero and an upper bound of the range for the offset value is based at least in part on a power headroom of the UE associated with PRACH transmission.

Aspect 6: The method of any of aspects 1 through 5, wherein the multiple power levels are different from multiple previous power levels associated with a previous time period and the multiple PRACH signals is transmitted based at least in part on a failure to receive a previous response message detected during the previous time period.

Aspect 7: The method of aspect 6, wherein the multiple power levels are higher than the multiple previous power levels.

Aspect 8: The method of any of aspects 1 through 7, further comprising: receiving an indication of a first set of time resources, frequency resources, or spatial resources associated with the power range.

Aspect 9: The method of aspect 8, wherein the first set of time resources, frequency resources, or spatial resources is different from a second set of time resources, frequency resources, or spatial resources associated with an additional power range.

Aspect 10: The method of any of aspects 1 through 9, wherein the multiple power levels are randomly or pseudo-randomly selected according to a uniform randomness within the power range defined for the multiple PRACH signals.

Aspect 11: The method of any of aspects 1 through 10, wherein the multiple power levels are randomly or pseudo-randomly selected according to a uniform randomness within a defined set of discrete power levels within the power range defined for the multiple PRACH signals.

Aspect 12: The method of any of aspects 1 through 11, wherein the multiple power levels are randomly or pseudo-randomly selected according to a random or pseudorandom permutation of a defined set of discrete power levels within the power range defined for the multiple PRACH signals.

Aspect 13: The method of any of aspects 1 through 12, wherein the multiple power levels comprises a first set of discrete power levels that is randomly or pseudo-randomly selected from multiple sets of discrete power levels within the power range defined for the multiple PRACH signals.

Aspect 14: A method for wireless communications at a network entity, comprising: receiving multiple PRACH signals at multiple power levels during a time period, wherein the multiple power levels are randomly or pseudo-randomly selected from within a power range defined for the multiple PRACH signals; transmitting a response message indicating one or more PRACH signals of the multiple PRACH signals detected during the time period; and receiving a random access request message at a first power level of the multiple power levels according to the one or more PRACH signals of the multiple PRACH signals detected during the time period.

Aspect 15: The method of aspect 14, further comprising: transmitting an indication of a lower bound and an upper bound associated with the power range defined for the multiple PRACH signals.

Aspect 16: The method of any of aspects 14 through 15, further comprising: transmitting an indication of a range for an offset value, wherein a lower bound of the range for the offset value is zero and an upper bound of the range for the offset value is based at least in part on a power headroom of a UE associated with PRACH transmission.

Aspect 17: The method of any of aspects 14 through 16, wherein the multiple power levels are different from multiple previous power levels associated with a previous time period and receiving the multiple PRACH signals is based at least in part on a failure to transmit a previous response message detected during the previous time period.

Aspect 18: The method of aspect 17, wherein the multiple power levels are higher than the multiple previous of power levels.

Aspect 19: The method of any of aspects 14 through 18, further comprising: transmitting an indication of a first set of time resources, frequency resources, or spatial resources associated with the power range.

Aspect 20: The method of aspect 19, wherein the first set of time resources, frequency resources, or spatial resources is different from a second set of time resources, frequency resources, or spatial resources associated with an additional power range.

Aspect 21: A UE for wireless communications, comprising one or more memories storing processor-executable code, and one or more processors coupled with the one or more memories and individually or collectively operable to execute the code to cause the UE to perform a method of any of aspects 1 through 13.

Aspect 22: A UE for wireless communications, comprising at least one means for performing a method of any of aspects 1 through 13.

Aspect 23: A non-transitory computer-readable medium storing code for wireless communications, the code comprising instructions executable by a processor to perform a method of any of aspects 1 through 13.

Aspect 24: A network entity for wireless communications, comprising one or more memories storing processor-executable code, and one or more processors coupled with the one or more memories and individually or collectively operable to execute the code to cause the network entity to perform a method of any of aspects 14 through 20.

Aspect 25: A network entity for wireless communications, comprising at least one means for performing a method of any of aspects 14 through 20.

Aspect 26: A non-transitory computer-readable medium storing code for wireless communications, the code comprising instructions executable by a processor to perform a method of any of aspects 14 through 20.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit multiple physical random access channel (PRACH) signals at multiple power levels during a time period, wherein the multiple power levels are randomly or pseudo-randomly selected from within a power range defined for the multiple PRACH signals;
receive a response message indicating one or more PRACH signals of the multiple PRACH signals detected during the time period; and
transmit a random access request message at a first power level of the multiple power levels according to the one or more PRACH signals of the multiple PRACH signals detected during the time period.

2. The UE of claim 1, wherein the one or more processors are individually or collectively further operable to execute the code to cause the UE to:
receive an indication of a lower bound and an upper bound associated with the power range defined for the multiple PRACH signals.

3. The UE of claim 1, wherein the one or more processors are individually or collectively further operable to execute the code to cause the UE to:
perform a first open loop power control computation based at least in part on a first downlink pathloss parameter to obtain a lower bound associated with the power range defined for the multiple PRACH signals; and
perform a second open loop power control computation based at least in part on a second downlink pathloss parameter to obtain an upper bound associated with the power range defined for the multiple PRACH signals.

4. The UE of claim 1, wherein, to transmit the multiple PRACH signals at the multiple power levels, the one or more processors are individually or collectively operable to execute the code to cause the UE to:
randomly or pseudo-randomly select, for each PRACH signal of the multiple PRACH signals, an offset value such that a power level of the multiple power levels is based at least in part on a sum of an open loop power control value and the offset value.

5. The UE of claim 4, wherein the one or more processors are individually or collectively further operable to execute the code to cause the UE to:
receive an indication of a range for the offset value, wherein a lower bound of the range for the offset value is zero and an upper bound of the range for the offset value is based at least in part on a power headroom of the UE associated with PRACH transmission.

6. The UE of claim 1, wherein the multiple power levels are different from multiple previous power levels associated with a previous time period and the multiple PRACH signals is transmitted based at least in part on a failure to receive a previous response message detected during the previous time period.

7. The UE of claim 6, wherein the multiple power levels are higher than the multiple previous power levels.

8. The UE of claim 1, wherein the one or more processors are individually or collectively further operable to execute the code to cause the UE to:
receive an indication of a first set of time resources, frequency resources, or spatial resources associated with the power range.

9. The UE of claim 8, wherein the first set of time resources, frequency resources, or spatial resources is different from a second set of time resources, frequency resources, or spatial resources associated with an additional power range.

10. The UE of claim 1, wherein the multiple power levels are randomly or pseudo-randomly selected according to a uniform randomness within the power range defined for the multiple PRACH signals.

11. The UE of claim 1, wherein the multiple power levels are randomly or pseudo-randomly selected according to a uniform randomness within a defined set of discrete power levels within the power range defined for the multiple PRACH signals.

12. The UE of claim 1, wherein the multiple power levels are randomly or pseudo-randomly selected according to a random or pseudorandom permutation of a defined set of discrete power levels within the power range defined for the multiple PRACH signals.

13. The UE of claim 1, wherein the multiple power levels comprises a first set of discrete power levels that is randomly or pseudo-randomly selected from multiple sets of discrete power levels within the power range defined for the multiple PRACH signals.

14. A network entity, comprising:
one or more memories storing processor-executable code; and
one or more processors coupled with the one or more memories and individually or collectively operable to execute the code to cause the network entity to:
receive multiple physical random access channel (PRACH) signals at multiple power levels during a time period, wherein the multiple power levels are randomly or pseudo-randomly selected from within a power range defined for the multiple PRACH signals;
transmit a response message indicating one or more PRACH signals of the multiple PRACH signals detected during the time period; and
receive a random access request message at a first power level of the multiple power levels according to the one or more PRACH signals of the multiple PRACH signals detected during the time period.

15. The network entity of claim 14, wherein the one or more processors are individually or collectively further operable to execute the code to cause the network entity to:
transmit an indication of a lower bound and an upper bound associated with the power range defined for the multiple PRACH signals.

16. The network entity of claim 14, wherein the one or more processors are individually or collectively further operable to execute the code to cause the network entity to:
transmit an indication of a range for an offset value, wherein a lower bound of the range for the offset value is zero and an upper bound of the range for the offset value is based at least in part on a power headroom of a user equipment (UE) associated with PRACH transmission.

17. The network entity of claim 14, wherein the multiple power levels are different from multiple previous power levels associated with a previous time period and receiving the multiple PRACH signals is based at least in part on a failure to transmit a previous response message detected during the previous time period.

18. The network entity of claim 17, wherein the multiple power levels are higher than the multiple previous power levels.

19. The network entity of claim 14, wherein the one or more processors are individually or collectively further operable to execute the code to cause the network entity to:
transmit an indication of a first set of time resources, frequency resources, or spatial resources associated with the power range.

20. The network entity of claim 19, wherein the first set of time resources, frequency resources, or spatial resources is different from a second set of time resources, frequency resources, or spatial resources associated with an additional power range.

21. A method for wireless communications at a user equipment (UE), comprising:
transmitting multiple physical random access channel (PRACH) signals at multiple power levels during a time period, wherein the multiple power levels are randomly or pseudo-randomly selected from within a power range defined for the multiple PRACH signals;
receiving a response message indicating one or more PRACH signals of the multiple PRACH signals detected during the time period; and
transmitting a random access request message at a first power level of the multiple power levels according to the one or more PRACH signals of the multiple PRACH signals detected during the time period.

22. The method of claim 21, further comprising:
receiving an indication of a lower bound and an upper bound associated with the power range defined for the multiple PRACH signals.

23. The method of claim 21, further comprising:
performing a first open loop power control computation based at least in part on a first downlink pathloss parameter to obtain a lower bound associated with the power range defined for the multiple PRACH signals; and
performing a second open loop power control computation based at least in part on a second downlink pathloss parameter to obtain an upper bound associated with the power range defined for the multiple PRACH signals.

24. The method of claim 21, wherein transmitting the multiple PRACH signals at the multiple power levels comprises:
randomly or pseudo-randomly selecting, for each PRACH signal of the multiple PRACH signals, an offset value such that a power level of the multiple power levels is based at least in part on a sum of an open loop power control value and the offset value.

25. The method of claim 24, further comprising:
receiving an indication of a range for the offset value, wherein a lower bound of the range for the offset value is zero and an upper bound of the range for the offset value is based at least in part on a power headroom of the UE associated with PRACH transmission.

26. The method of claim 21, wherein the multiple power levels are different from multiple previous power levels associated with a previous time period and the multiple PRACH signals is transmitted based at least in part on a failure to receive a previous response message detected during the previous time period.

27. The method of claim 21, further comprising:
receiving an indication of a first set of time resources, frequency resources, or spatial resources associated with the power range.

28. The method of claim 27, wherein the first set of time resources, frequency resources, or spatial resources is different from a second set of time resources, frequency resources, or spatial resources associated with an additional power range.

29. A method for wireless communications at a network entity, comprising:
receiving multiple physical random access channel (PRACH) signals at multiple power levels during a time period, wherein the multiple power levels are randomly or pseudo-randomly selected from within a power range defined for the multiple PRACH signals;
transmitting a response message indicating one or more PRACH signals of the multiple PRACH signals detected during the time period; and
receiving a random access request message at a first power level of the multiple power levels according to the one or more PRACH signals of the multiple PRACH signals detected during the time period.

30. The method of claim 29, further comprising:
transmitting an indication of a lower bound and an upper bound associated with the power range defined for the multiple PRACH signals.
